(19) United States
(12) Patent Application Publication
(10) Pub. No.: US 2021/0223674 A1
(43) Pub. Date: Jul. 22, 2021

(54) PROJECTION SYSTEM AND PROJECTOR

(71) Applicant: SEIKO EPSON CORPORATION, Tokyo (JP)

(72) Inventors: Eiji MORIKUNI, Matsumoto-shi (JP); Kaho WATANABE, Matsumoto-shi (JP)

(73) Assignee: SEIKO EPSON CORPORATION, Tokyo (JP)

(21) Appl. No.: 17/152,307

(22) Filed: Jan. 19, 2021

(30) Foreign Application Priority Data
Jan. 20, 2020 (JP) 2020-006668

(51) Int. Cl. G03B 21/28; G02B 13/16; G02B 13/18; G03B 21/14

(52) U.S. Cl. CPC G03B 21/28; G03B 21/142; G02B 13/18; G02B 13/16

(57) ABSTRACT

A projection system includes a first optical system and a second optical system including an optical element and disposed at the enlargement side of the first optical system. The first optical system includes a first lens and a second lens disposed at the reduction side of the first lens. The optical element has a first transmissive surface, a reflection surface disposed at the enlargement side of the first transmissive surface, and a second transmissive surface disposed at the enlargement side of the reflection surface. The first lens has aspheric surfaces at opposite sides. The second lens has aspheric surfaces at opposite sides. At least one of the first and second lenses is configured to move in an optical axis direction along a first optical axis of the first optical system.

The present application is based on, and claims priority from JP Application Serial Number 2020-006668, filed Jan. 20, 2020, the disclosure of which is hereby incorporated by reference herein in its entirety.

### BACKGROUND

### 1. Technical Field

The present disclosure relates to a projection system and a projector.

### 2. Related Art

JP-A-2010-20344 describes a projector that enlarges and projects a projection image formed by an image formation section via a projection system. The projection system described in JP-A-2010-20344 is formed of a first optical system and a second optical system sequentially arranged from the reduction side toward the enlargement side. The first optical system includes a refractive optical system including a plurality of lenses. The second optical system is formed of a reflection mirror having a concave reflection surface. The image formation section includes a light source and a light valve. The image formation section forms a projection image in the reduction-side image formation plane of the projection system. The projection system forms an intermediate image in a position between the first optical system and the reflection surface and projects a final image on a screen disposed on the enlargement-side image formation plane of the projection system.

The projection system and the projector are required to have a shorter projection distance. An attempt to further shorten the projection distance in the configuration using the projection system described in JP-A-2010-20344, however, causes a problem of a difficulty in designing the projection system.

### SUMMARY

To solve the problem described above, a projection system according to an aspect of the present disclosure includes a first optical system and a second optical system including an optical element and disposed on an enlargement side of the first optical system. The first optical system includes a first lens and a second lens disposed at a reduction side of the first lens. The optical element has a first transmissive surface, a reflection surface disposed at the enlargement side of the first transmissive surface, and a second transmissive surface disposed at the enlargement side of the reflection surface. The first lens has aspheric surfaces at opposite sides. The second lens has aspheric surfaces at opposite sides. At least one of the first and second lenses is moved in an optical axis direction along a first optical axis of the first optical system.

A projection system according to another aspect of the present disclosure includes a first optical system and a second optical system including an optical element and disposed at an enlargement side of the first optical system. The first optical system includes a first lens and a second lens disposed at a reduction side of the first lens. The optical element has a first transmissive surface, a reflection surface disposed at the enlargement side of the first transmissive surface, and a second transmissive surface disposed at the enlargement side of the reflection surface. The optical element is configured to move in an optical axis direction along a first optical axis of the first optical system.

A projector according to another aspect of the present disclosure includes the projection system described above and an image formation section that forms a projection image on a reduction-side image formation plane of the projection system.

### BRIEF DESCRIPTION OF THE DRAWINGS

FIG. 1 is a schematic configuration diagram of a projector including a projection system.

FIG. 2 is a light ray diagram diagrammatically showing the entire projection system when the projection distance is a reference distance.

FIG. 3 is a light ray diagram diagrammatically showing the entire projection system when the projection distance is a short distance.

FIG. 4 is a light ray diagram diagrammatically showing the entire projection system when the projection distance is a long distance.

FIG. 5 is a light ray diagram of the light rays passing through the projection system.

FIG. 6 is a light ray diagram of the light rays passing through a second optical system.

FIG. 7 describes the projection system according to Example 1.

FIG. 8 describes the projection system according to Example 2.

FIG. 9 describes the projection system according to Example 3.

FIG. 10 describes the projection system according to Example 4.

FIG. 11 describes the projection system according to Example 5.

FIG. 12 describes the projection system according to Example 6.

FIG. 13 describes the projection system according to Example 7.

FIG. 14 describes the projection system according to Example 8.

FIG. 15 describes the projection system according to Example 9.

### DESCRIPTION OF EXEMPLARY EMBODIMENTS

A projection system according to an embodiment of the present disclosure and a projector including the projection system will be described below in detail with reference to the drawings.

### Projector

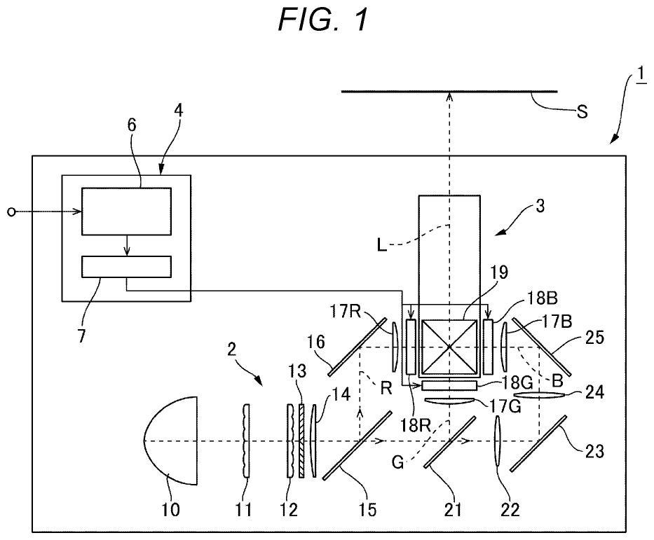

FIG. 1 is a schematic configuration diagram of a projector including a projection system 3 according to the present disclosure. A projector 1 includes an image formation section 2, which generates a projection image to be projected on a screen S, the projection system 3, which enlarges the projection image and projects the enlarged image on the screen S, and a controller 4, which controls the action of the image formation section 2, as shown in FIG. 1.

### Image Generation Optical System and Controller

The image formation section 2 includes alight source 10, a first optical integration lens 11, a second optical integration lens 12, a polarization converter 13, and a superimposing lens 14. The light source 10 is formed, for example, of an ultrahigh-pressure mercury lamp or a solid-state light source. The first optical integration lens 11 and the second optical integration lens 12 each include a plurality of lens elements arranged in an array. The first optical integration lens 11 divides the light flux from the light source 10 into a plurality of light fluxes. The lens elements of the first optical integration lens 11 focus the light flux from the light source 10 in the vicinity of the lens elements of the second optical integration lens 12.

The polarization converter 13 converts the light via the second optical integration lens 12 into predetermined linearly polarized light. The superimposing lens 14 superimposes images of the lens elements of the first optical integration lens 11 on one another in a display area of each of liquid crystal panels 18R, 18G, and 18B, which will be described later, via the second optical integration lens 12.

The image formation section 2 further includes a first dichroic mirror 15, a reflection mirror 16, a field lens 17R, and the liquid crystal panel 18R. The first dichroic mirror 15 reflects R light, which is part of the light rays incident via the superimposing lens 14, and transmits G light and B light, which are part of the light rays incident via the superimposing lens 14. The R light reflected off the first dichroic mirror 15 travels via the reflection mirror 16 and the field lens 17R and is incident on the liquid crystal panel 18R. The liquid crystal panel 18R is a light modulator. The liquid crystal panel 18R modulates the R light in accordance with an image signal to form a red projection image.

The image formation section 2 further includes a second dichroic mirror 21, a field lens 17G, and the liquid crystal panel 18G. The second dichroic mirror 21 reflects the G light, which is part of the light rays via the first dichroic mirror 15, and transmits the B light, which is part of the light rays via the first dichroic mirror 15. The G light reflected off the second dichroic mirror 21 passes through the field lens 17G and is incident on the liquid crystal panel 18G. The liquid crystal panel 18G is a light modulator. The liquid crystal panel 18G modulates the G light in accordance with an image signal to form a green projection image.

The image formation section 2 further includes a relay lens 22, a reflection mirror 23, a relay lens 24, a reflection mirror 25, a field lens 17B, and the liquid crystal panel 18B. The B light having passed through the second dichroic mirror 21 travels via the relay lens 22, the reflection mirror 23, the relay lens 24, the reflection mirror 25, and the field lens 17B and is incident on the liquid crystal panel 18B. The liquid crystal panel 18B is a light modulator. The liquid crystal panel 18B modulates the B light in accordance with an image signal to form a blue projection image.

The liquid crystal panels 18R, 18G, and 18B surround a cross dichroic prism 19 in such a way that the liquid crystal panels 18R, 18G, and 18B face three sides of the cross dichroic prism 19. The cross dichroic prism 19, which is a prism for light combination, produces a projection image that is the combination of the light modulated by the liquid crystal panel 18R, the light modulated by the liquid crystal panel 18G, and the light modulated by the liquid crystal panel 18B.

The cross dichroic prism 19 forms part of the projection system 3. The projection system 3 enlarges and projects the projection images (images formed by liquid crystal panels 18R, 18G, and 18B) combined by the cross dichroic prism 19 on the screen S. The screen S is the enlargement-side image formation plane of the projection system 3.

The controller 4 includes an image processor 6, to which an external image signal, such as a video signal, is inputted, and a display driver 7, which drives the liquid crystal panels 18R, 18G, and 18B based on image signals outputted from the image processor 6.

The image processor 6 converts the image signal inputted from an external apparatus into image signals each containing grayscales and other factors of the corresponding color. The display driver 7 operates the liquid crystal panels 18R, 18G, and 18B based on the color projection image signals outputted from the image processor 6. The image processor 6 thus causes the liquid crystal panels 18R, 18G, and 18B to display projection images corresponding to the image signals.

### Projection System

Examples of the projection system 3 incorporated in the projector 1 will be described below. The projection distance of the projection system 3 can be changed among a prespecified reference distance J1, a short distance J2, which is shorter than the reference distance J1, and a long distance J3, which is longer than the reference distance J1.

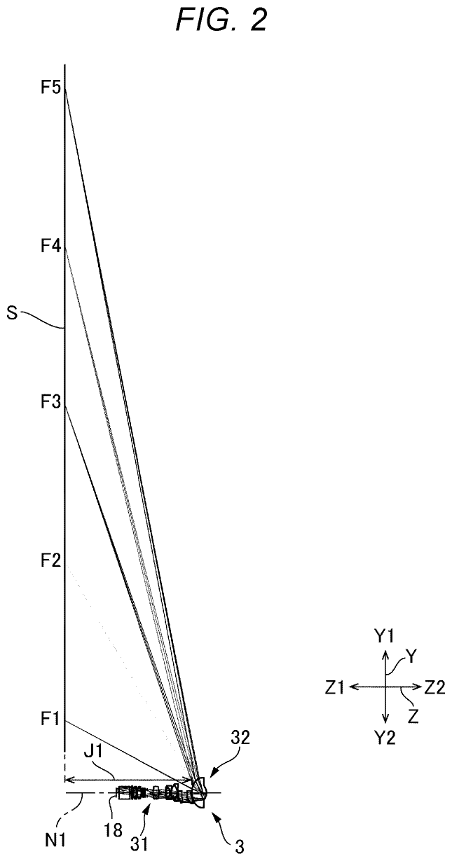

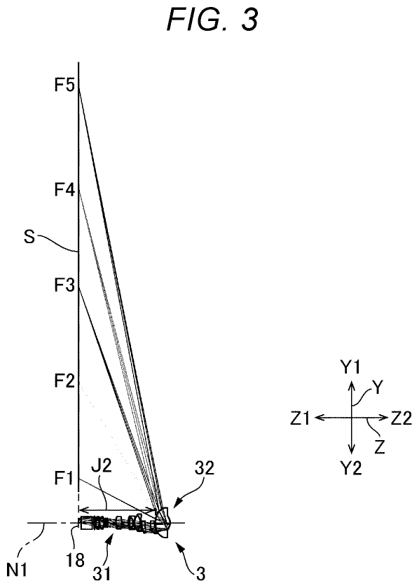

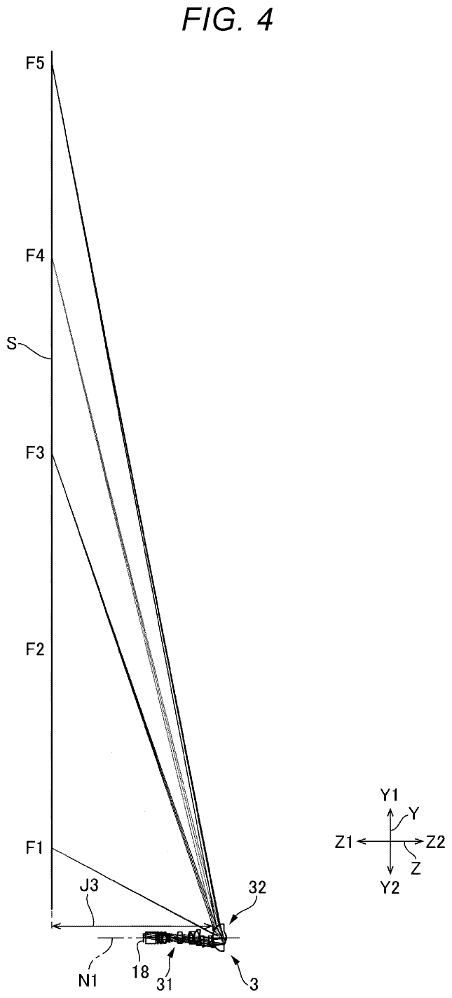

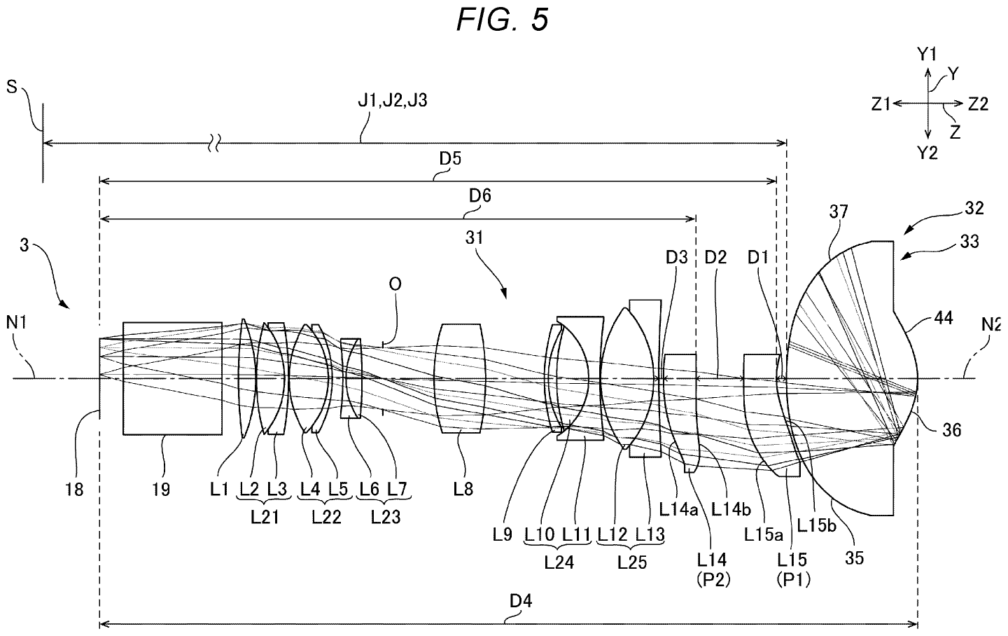

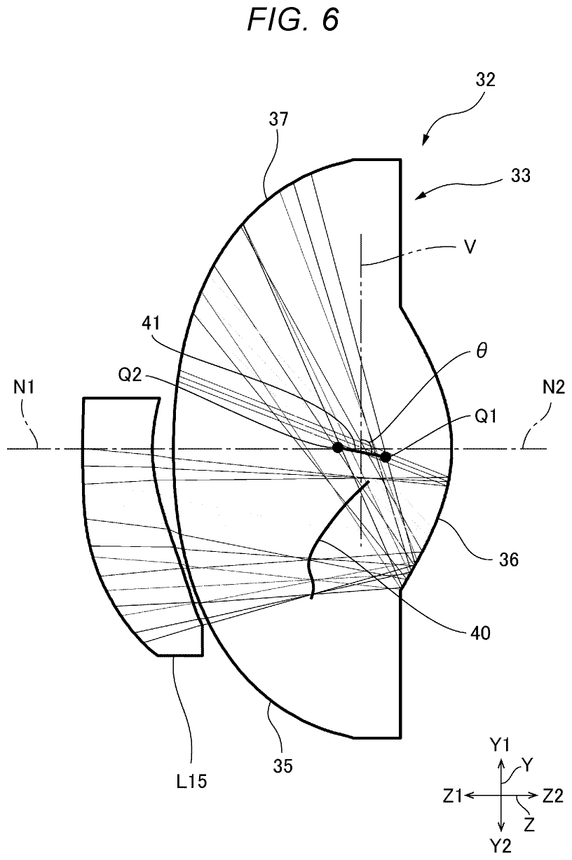

FIG. 2 is a light ray diagram diagrammatically showing the entire projection system 3 when the projection is performed over the reference distance J1. FIG. 3 is a light ray diagram diagrammatically showing the entire projection system 3 when the projection is performed over the short distance J2. FIG. 4 is a light ray diagram diagrammatically showing the entire projection system 3 when the projection is performed over the long distance J3. FIG. 5 is a light ray diagram of the light rays passing through the projection system 3 when the projection is performed over the reference distance J1. FIG. 6 is a light ray diagram of the light rays passing through a second optical system 32 of the projection system 3 when the projection is performed over the reference distance J1. FIGS. 2, 3, and 4 diagrammatically show light fluxes F1 to F5, which exit out of the projection system 3 according to the examples of the present disclosure and reach the screen S. The light flux F1 is a light flux that reaches a smallest image height position. The light flux F5 is a light flux that reaches a largest image height position. The light flux F3 is a light flux that reaches a position between the position that the light flux F1 reaches and the position that the light flux F5 reaches. The light flux F2 is a light flux that reaches a position between the position that the light flux F1 reaches and the position that the light flux F3 reaches. The light flux F4 is a light flux that reaches a position between the position that the light flux F3 reaches and the position that the light flux F5 reaches. In the following figures and description, the liquid crystal panels 18R, 18G, and 18B are referred to as liquid crystal panels 18.

The projection system 3 is formed of a first optical system 31 and the second optical system 32 sequentially arranged from the reduction side toward the enlargement side, as shown in FIG. 5. The first optical system 31 is a refractive optical system including a plurality of lenses. The second optical system 32 is formed of one optical element 33. The optical element 33 has a first transmissive surface 35, a reflection surface 36, and a second transmissive surface 37 sequentially arranged from the reduction side toward the enlargement side. The first transmissive surface 35 has a convex shape protruding toward the reduction side. The reflection surface 36 has a concave shape. The second transmissive surface 37 has a convex shape protruding toward the enlargement side. The optical element 33, which forms the second optical system 32, is disposed in a first optical axis N1 of the first optical system 31. In the second optical system 32, a second optical axis N2 of the reflection surface 36 coincides with the first optical axis N1.

The liquid crystal panels 18 of the image formation section 2 are disposed in the reduction-side image formation plane of the projection system 3. The liquid crystal panels 18 form projection images at one side of the first optical axis N1 of the first optical system 31. The screen S is disposed in the enlargement-side image formation plane of the projection system 3, as shown in FIGS. 2, 3, and 4. A final image is projected on the screen S. The screen S is located on the same side of the first optical axis N1 as the side where the liquid crystal panels 18 form the projection images. An intermediate image 40 conjugate with the reduction-side image formation plane and the enlargement-side image formation plane is formed between the first optical system 31 and the reflection surface 36 of the optical element 33. The intermediate image 40 is an image conjugate with the final image but turned upside down. In the examples of the present disclosure, the intermediate image 40 is formed inside the optical element 33. More specifically, the intermediate image 40 is formed between the first transmissive surface 35 and the reflection surface 36 of the optical element 33.

In the following description, three axes perpendicular to one another are called axes X, Y, and Z for convenience. The rightward/leftward direction of the screen S, which is the enlargement-side image formation plane, is called an axis-X direction, the upward/downward direction of the screen S is called an axis-Y direction, and the direction perpendicular to the screen S is called an axis-Z direction. An axis-Z direction is an optical axis direction along the first optical axis N1 of the first optical system 31. The axis-Z direction toward the side where the first optical system 31 is located is called a first direction Z1, and the axis-Z direction toward the side where the second optical system 32 is located is called a second direction Z2. The plane containing the first optical axis N1 of the first optical system 31, the second optical axis N2 of the reflection surfaces 36 of the optical element 33, and the axis Y is called a plane YZ. FIGS. 2 to 6 are each a light ray diagram in the plane YZ. The first optical axis N1 and the second optical axis N2 extend along the axis-Z direction. The liquid crystal panels 18 form the projection images at an upper side Y1 of the first optical axis N1 of the first optical system 31. The screen S is disposed at the upper side Y1 of the first optical axis N1 of the first optical system 31. The intermediate image 40 is formed at a lower side Y2 of the first optical axis N1.

The first optical system 31 includes the cross dichroic prism 19 and 15 lenses L1 to L15, as shown in FIG. 5. The lenses L1 to L15 are arranged in the presented order from the reduction side toward the enlargement side. In the examples of the present disclosure, the lenses L2 and L3 are bonded to each other into a first doublet L21. The lenses L4 and L5 are bonded to each other into a second doublet L22. The lenses L6 and L7 are bonded to each other into a third doublet L23. The lenses L10 and L11 are bonded to each other into a fourth doublet L24. The lenses L12 and L13 are bonded to each other into a fifth doublet L25. An aperture O is disposed between the third doublet L23 and the lens L8.

In the first optical system 31, the lens L15 (first lens), which is located in a position closest to the enlargement side, has aspheric surfaces both at the enlargement and reduction sides. Further, in the first optical system 31, the lens L14 (second lens), which is the second lens next to the lens closest to the enlargement side, also has aspheric surfaces both at the enlargement and reduction sides. The positions of the lenses L15 and L14 when the projection distance is the reference distance J1 are called a first reference position P1 and a second reference position P2, respectively.

In the first optical system 31, the lens L14 has positive power. The first optical system 31 as a whole has positive power. Between the first optical system 31 and the second optical system 32, the gap between the chief rays therein therefore decreases with distance to the second optical system 32.

The optical element 33 is designed by using the second optical axis N2 of the reflection surface 36 as the axis in the design stage. In other words, the second optical axis N2 is the design-stage optical axis of the first transmissive surface 35, the second transmissive surface 37, and the reflection surface 36. The first transmissive surface 35 and the reflection surface 36 are located at the lower side Y2 of the second optical axis N2, and the second transmissive surface 37 is located at the upper side Y1 of the second optical axis N2, as shown in FIGS. 5 and 6. In the examples of the present disclosure, the first transmissive surface 35, the reflection surface 36, and the second transmissive surface 37 of the optical element 33 each have a rotationally symmetric shape around the second optical axis N2. The first transmissive surface 35, the reflection surface 36, and the second transmissive surface 37 are each provided within an angular range of 180° around the second optical axis N2.

The first transmissive surface 35, the reflection surface 36, and the second transmissive surface 37 of the optical element 33 are each an aspheric surface. The reflection surface 36 is a reflection coating layer provided on a surface of the optical element 33 that is the surface opposite the first transmissive surface 35. The first transmissive surface 35, the reflection surface 36, and the second transmissive surface 37 may instead each be a free-form surface. The free-form surface is one form of the shape of an aspheric surface. In this case, the free-form surfaces are designed by using the second optical axis N2 as the design-stage axis. Therefore, also when any of the first transmissive surface 35, the reflection surface 36, and the second transmissive surface 37 is a free-form surface in the projection system 3, the second optical axis N2 of the reflection surface 36 is called the optical axis of the optical element 33.

A pupil 41 of the second optical system 32 is located inside the optical element 33, as shown in FIG. 6. The pupil 41 of the second optical system 32 in the plane YZ is defined by the line that connects an upper intersection Q1, where an upper peripheral light ray of an upper end light flux passing through the axis-Y-direction upper end of an effective light ray range of the second transmissive surface 37 and an upper peripheral light ray of a lower end light flux passing through the axis-Y-direction lower end of the effective light ray range intersect each other in the plane YZ, to a lower intersection Q2, where a lower peripheral light ray of the upper end light flux and a lower peripheral light ray of the lower end light flux intersect each other in the plane YZ.

The pupil 41 inclines with respect to an imaginary vertical line V perpendicular to the second optical axis N2 in the plane YZ. In the examples of the present disclosure, an inclination angle θ by which the pupil 41 inclines with respect to the imaginary vertical line V is greater than or equal to 90°. The inclination angle θ is the angle measured clockwise from the imaginary vertical line V in the plane of view of FIG. 6.

### Lens Data

Data on the lenses of the projection system 3 when the projection distance is the reference distance J1 are listed below. The surfaces of the lenses are numbered sequentially from the enlargement side toward the reduction side. An aspheric surface has a surface number preceded by * . Reference characters are given to the lenses and the mirror. Data labeled with a surface number that does not correspond to any of the lenses or the mirror is dummy data. Reference character r denotes the radius of curvature. Reference character d denotes the axial inter-surface distance. Reference character nd denotes the refractive index. Reference character vd denotes the Abbe number. Reference character Y denotes the effective radius. Reference characters r, d, and Y are each expressed in millimeters.

| Surface number | Name | r | d | nd | vd | Mode | Y |
|---|---|---|---|---|---|---|---|
| Object plane | S | 0 | 0 | | | Refraction | |
| 1 | | 0 | 352.380866 | | | Refraction | 2579.348 |
| *2 | 37 | 80 | 40 | 1.509398 | 56.47 | Refraction | 38.346 |
| *3 | 36 | −21.45329 | −40 | 1.509398 | 56.47 | Refraction | 19.826 |
| *4 | 35 | 80 | −3.463576 | | | Refraction | 24.319 |
| *5 | L15 | 21.86637 | −10 | 1.531131 | 55.75 | Refraction | 24.546 |
| *6 | | 436.34945 | −14.543248 | | | Refraction | 27.053 |
| *7 | L14 | −1019.40089 | −9.958351 | 1.531131 | 55.75 | Refraction | 25.807 |
| *8 | | 56.8871 | −1.298711 | | | Refraction | 25.095 |
| 9 | L13 | 359.11364 | −1.55686 | 1.925108 | 25.06 | Refraction | 21.554 |
| 10 | L12 | −29.75138 | −16.174918 | 1.479539 | 54.04 | Refraction | 19.577 |
| 11 | | 33.84113 | −0.2 | | | Refraction | 19.519 |
| 12 | L11 | 135.07956 | −3.46457 | 1.804198 | 46.5 | Refraction | 16.859 |
| 13 | L10 | −19.55005 | −9.774641 | 1.705864 | 22.31 | Refraction | 14.745 |
| 14 | | 52.81257 | −2.53405 | | | Refraction | 14.5 |
| 15 | L09 | 27.71432 | −1.203892 | 1.7552 | 27.53 | Refraction | 14.488 |
| 16 | | 51.12883 | −17.9113 | | | Refraction | 14.77 |
| 17 | L08 | −72.93096 | −15.802377 | 1.56732 | 42.84 | Refraction | 15.182 |
| 18 | | 50.19562 | −15.600299 | | | Refraction | 14.497 |
| 19 | | 0 | −6.349998 | | | Refraction | 9 |
| 20 | L07 | −132.96998 | −4.864842 | 1.443212 | 84.91 | Refraction | 9.925 |
| 21 | L06 | 20.09476 | −0.971883 | 1.920189 | 26.24 | Refraction | 10.012 |
| 22 | | −87.71137 | −3.197082 | | | Refraction | 10.896 |
| 23 | L05 | −31.57725 | −1.229315 | 1.817534 | 43.38 | Refraction | 14.759 |
| 24 | L04 | −22.21043 | −11.924016 | 1.495575 | 47.26 | Refraction | 14.786 |
| 25 | | 29.3413 | −0.2 | | | Refraction | 15.253 |
| 26 | L03 | −93.55096 | −1.220128 | 1.953747 | 32.32 | Refraction | 15.591 |
| 27 | L02 | −24.67121 | −8.605999 | 1.462081 | 84.59 | Refraction | 15.314 |
| 28 | | 58.24298 | −0.2 | | | Refraction | 15.569 |
| 29 | L01 | −44.76054 | −5.256438 | 1.75211 | 25.05 | Refraction | 16.641 |
| 30 | | 132.15006 | −5 | | | Refraction | 16 |
| 31 | 19 | 0 | −30.093 | 1.51633 | 64.14 | Refraction | 15.557 |
| 32 | | 0 | −7.287 | | | Refraction | 12.854 |
| Image plane | 18 | 0 | 0 | | | Refraction | 11.855 |

The aspheric constants of each of the aspheric surfaces are listed below.

| Surface number | 2 |
|---|---|
| Conic constant | 2.983141E+00 |
| Fourth-order coefficient | 4.037066E−06 |
| Sixth-order coefficient | −2.814271E−09 |
| Eighth-order coefficient | 1.375816E−12 |
| Tenth-order coefficient | −9.428999E−17 |
| Surface number | 3 |
| Conic constant | −3.949636E+00 |
| Fourth-order coefficient | −1.892617E−05 |
| Sixth-order coefficient | 5.345062E−08 |
| Eighth-order coefficient | −8.165052E−11 |
| Tenth-order coefficient | 6.242483E−14 |
| Surface number | 4 |
| Conic constant | 2.983141E+00 |
| Fourth-order coefficient | 4.037066E−06 |
| Sixth-order coefficient | −2.814271E−09 |
| Eighth-order coefficient | 1.375816E−12 |
| Tenth-order coefficient | −9.428999E−17 |
| Surface number | 5 |
| Conic constant | −3.119399E+00 |
| Fourth-order coefficient | −1.811605E−05 |
| Sixth-order coefficient | 4.168208E−08 |
| Eighth-order coefficient | −7.376799E−11 |
| Tenth-order coefficient | 6.173719E−14 |
| Surface number | 6 |
| Conic constant | 3.597936E+00 |
| Fourth-order coefficient | 2.978469E−05 |
| Sixth-order coefficient | −3.366763E−08 |
| Eighth-order coefficient | 1.632336E−11 |
| Tenth-order coefficient | 2.06852E−15 |
| Surface number | 7 |
| Conic constant | 6.175424E+01 |
| Fourth-order coefficient | 1.32437E−05 |
| Sixth-order coefficient | −1.018409E−08 |
| Eighth-order coefficient | −1.578957E−11 |
| Tenth-order coefficient | 6.964825E−15 |

### Change in Projection Distance

A description will next be made of the lens positions when the projection distance is changed from the reference distance J1 to the short distance J2 and a case where the projection distance is changed from the reference distance J1 to the long distance J3. Light rays used in the simulation in each example are so weighted that the weighting ratio among light rays having a wavelength of 620 nm, light rays having a wavelength of 550 nm, and light rays having a wavelength of 470 nm is 2:7:1.

### Example 1

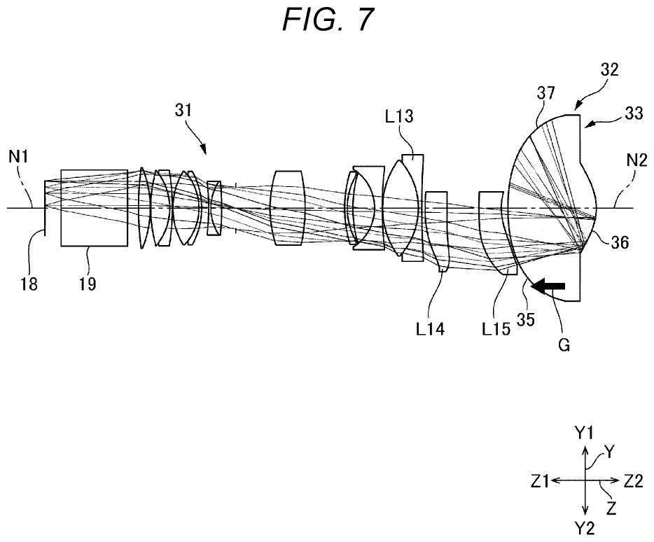

FIG. 7 describes Example 1. In the present example, when the projection distance is changed, the optical element 33, which forms the second optical system 32, is moved in the axis-Z direction. That is, when the projection distance is changed from the reference distance J1 to the long distance J3, the optical element 33 is moved in the first direction Z1, as indicated by the arrow G in FIG. 7. When the projection distance is changed from the reference distance J1 to the short distance J2, the optical element 33 is moved in the second direction Z2.

The axial inter-surface distances at each of the projection distances of the projection system 3 are listed below. In the data on the axial inter-surface distance shown below, the values in the field S1 are the projection distances labeled with J1, J2, and J3 in FIG. 5. In other words, the values in the field S1 are the reference distance J1 shown in FIG. 2, the short distance J2 shown in FIG. 3, and the long distance J3 shown in FIG. 4. That is, the values in the field S1 each represent the axial inter-surface distance between the second transmissive surface 37 of the optical element 33 and the screen S in the axis-Z direction. The values in the field S4 each represent an axial inter-surface distance D1 between the first transmissive surface 35 of the optical element 33 and the lens L15 of the first optical system 31, as shown in FIG. 5. The values in the field S6 each represent an axial inter-surface distance D2 between a reduction-side surface L15a of the lens L15 and the lens L14 of the first optical system 31. The values in the field S8 each represent an axial inter-surface distance D3 between a reduction-side surface L14a of the lens L14 and the lens L13 of the first optical system 31. The values in the field S3-S33 each represent an axial inter-surface distance D4 between the reflection surface 36 of the optical element 33 and the liquid crystal panels 18. The values in the field S5-S33 each represent an axial inter-surface distance D5 between an enlargement-side surface L15b of the lens L15 of the first optical system 31 and the liquid crystal panels 18. The values in the field S7-S33 each represent an axial inter-surface distance D6 between an enlargement-side surface L14b of the lens L14 of the first optical system 31 and the liquid crystal panels 18.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −3.990511597 | −3.251697307 |
| S6(D2) | −14.54324832 | −14.54324832 | −14.54324832 |
| S8(D3) | −1.29871095 | −1.29871095 | −1.29871095 |
| S3-S33(D4) | −249.886 | −250.413 | −249.675 |
| S5-S33(D5) | −206.423 | −206.423 | −206.423 |
| S7-S33(D6) | −181.88 | −181.88 | −181.88 |

In the present example, when the projection distance is changed, only the optical element 33 is moved, as shown in the data on the axial inter-surface distance. The lenses L1 to L15 of the first optical system 31 are fixed.

According to the present example, only the movement of the optical element 33 can change the projection distance. Therefore, in the present example, focusing can be performed by providing a barrel that holds the projection system 3 or a frame that forms the projector 1 and supports the projection system 3 with a support mechanism that movably supports the optical element 33.

### Example 2

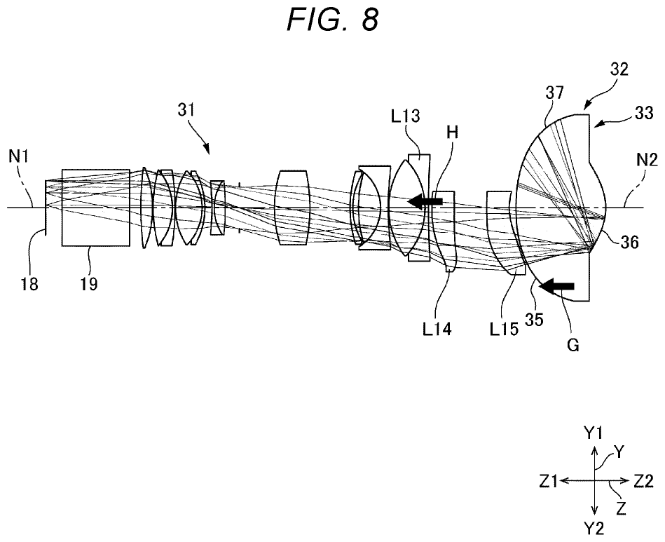

FIG. 8 describes Example 2. In the present example, when the projection distance is changed, the optical element 33 and the lens L14 of the first optical system 31 are moved in the axis-Z direction. That is, when the projection distance is changed from the reference distance J1 to the long distance J3, the optical element 33 is moved in the first direction Z1, as indicated by the arrow G in FIG. 8. The lens L14 is also moved from the second reference position P2 in the first direction Z1, as indicated by the arrow H in FIG. 8. When the projection distance is changed from the reference distance J1 to the short distance J2, the optical element 33 is moved in the second direction Z2, and the lens L14 is moved in the second direction Z2. The lenses L1 to L13 and the lense L15 of the first optical system 31 are fixed. The axial inter-surface distances at each of the projection distances of the projection system 3 are listed below.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −3.978229505 | −3.247264835 |
| S6(D2) | −14.54324832 | −14.18086369 | −14.68016204 |
| S8(D3) | −1.29871095 | −1.661095584 | −1.161797229 |
| S3-S33(D4) | −249.886 | −250.401 | −249.67 |
| S5-S33(D5) | −206.423 | −206.423 | −206.423 |
| S7-S33(D6) | −181.88 | −182.242 | −181.743 |

According to the present example, movement of the optical element 33 and one lens of the first optical system 31 in the axis-Z direction can change the projection distance. The present example allows suppression of occurrence of astigmatism by a greater degree than in Example 1 when the projection distance is the short distance J2.

### Example 3

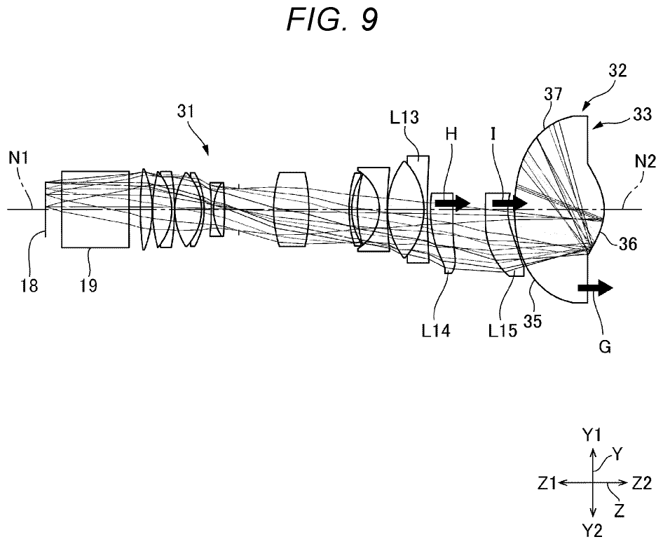

FIG. 9 describes Example 3. In the present example, when the projection distance is changed, the optical element 33, the lens L14 of the first optical system 31, and the lens L15 of the first optical system 31 are moved in the axis-Z direction. That is, when the projection distance is changed from the reference distance J1 to the long distance J3, the optical element 33 is moved in the second direction Z2, as indicated by the arrow G in FIG. 9. Further, the lens L14 is moved from the second reference position P2 in the second direction Z2, and the lens L15 is moved from the first reference position P1 in the second direction Z2, as indicated by the arrows H and I in FIG. 9. When the projection distance is changed from the reference distance J1 to the short distance J2, the optical element 33 is moved in the first direction Z1. Further, the lens L14 is moved from the second reference position P2 in the first direction Z1, and the lens L15 is moved from the first reference position P1 in the first direction Z1. The lenses L1 to L13 of the first optical system 31 are fixed. The axial inter-surface distances at each of the projection distances of the projection system 3 are listed below.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −4.377873328 | −3.102615287 |
| S6(D2) | −14.54324832 | −14.54324832 | −14.54324832 |
| S8(D3) | −1.29871095 | −0.149334295 | −1.739851126 |
| S3-S33(D4) | −249.886 | −249.651 | −249.967 |
| S5-S33(D5) | −206.423 | −205.274 | −206.864 |
| S7-S33(D6) | −181.88 | −180.73 | −182.321 |

In the present example, when the lenses L14 and L15 are moved, the axial inter-surface distance D2 between the lens L14 and the lens L15 is not changed, as indicated by the values in the field S6. That is, in the present example, the optical element 33 is moved in a predetermined direction, and the lenses L14 and L15 are moved by the same distance in the same direction as the direction in which the optical element 33 is moved.

The present example allows suppression of occurrence of astigmatism by a greater degree than in Examples 1 and 2 when the projection distance is the short distance J2. Further, in the present example, the lenses L14 and L15 of the first optical system 31 can be moved integrally with each other. Therefore, even when the one optical element 33 and the two lenses L14 and L15 are moved, the projection distance can be changed by providing the barrel or the frame with a first movement mechanism that supports the optical element 33 in such a way that the optical element 33 is movable in the axis-Z direction and a second movement mechanism that supports the lenses L14 and L15 in such a way that the lenses L14 and L15 are movable in the axis-Z direction.

### Example 4

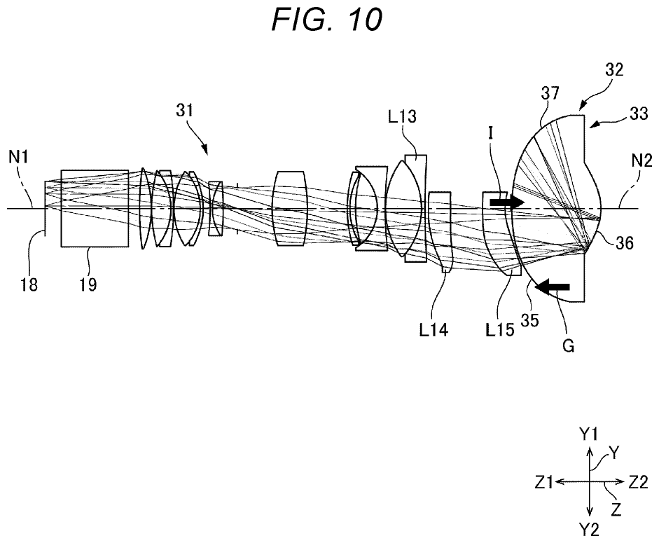

FIG. 10 describes Example 4. In the present example, when the projection distance is changed, the optical element 33 and the lens L15 of the first optical system 31 are moved in the axis-Z direction. That is, when the projection distance is changed from the reference distance J1 to the long distance J3, the optical element 33 is moved in the first direction Z1, as indicated by the arrow G in FIG. 10. Further, the lens L15 is moved from the first reference position P1 in the second direction Z2, as indicated by the arrow I in FIG. 10. When the projection distance is changed from the reference distance J1 to the short distance J2, the optical element 33 is moved in the second direction Z2. Further, the lens L15 is moved from the first reference position P1 in the first direction Z1. The lenses L1 to L14 of the first optical system 31 are fixed. The axial inter-surface distances at each of the projection distances of the projection system 3 are listed below.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −4.088640445 | −3.201555556 |
| S6(D2) | −14.54324832 | −14.22030577 | −14.67882161 |
| S8(D3) | −1.29871095 | −1.29871095 | −1.29871095 |
| S3-S33(D4) | −249.886 | −250.189 | −249.76 |
| S5-S33(D5) | −206.423 | −206.1 | −206.558 |
| S7-S33(D6) | −181.88 | −181.88 | −181.88 |

According to the present example, movement of the optical element 33 and one lens of the first optical system 31 in the axis-Z direction can change the projection distance.

### Example 5

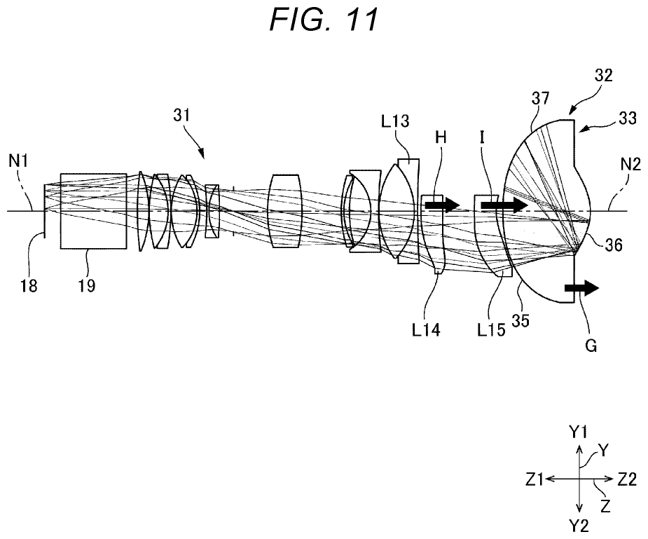

FIG. 11 describes Example 5. In the present example, when the projection distance is changed, the optical element 33, the lenses L14 and L15 of the first optical system 31 are moved in the axis-Z direction. That is, when the projection distance is changed from the reference distance J1 to the long distance J3, the optical element 33 is moved in the second direction Z2, as indicated by the arrow Gin FIG. 11. Further, the lens L14 is moved from the second reference position P2 in the second direction Z2, as indicated by the arrow H in FIG. 11, and the lens L15 is moved from the first reference position P1 in the second direction Z2, as indicated by the arrow I in FIG. 11. When the projection distance is changed from the reference distance J1 to the short distance J2, the optical element 33 is moved in the first direction Z1. Further, the lens L14 is moved from the second reference position P2 in the first direction Z1, and the lens L15 is moved from the first reference position P1 in the first direction Z1. The lenses L1 to L13 of the first optical system 31 are fixed. The axial inter-surface distances at each of the projection distances of the projection system 3 are listed below.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −4.260009958 | −3.120385337 |
| S6(D2) | −14.54324832 | −14.35007667 | −14.60329041 |
| S8(D3) | −1.29871095 | −0.667594791 | −1.6206495 |
| S3-S33(D4) | −249.886 | −249.859 | −249.925 |
| S5-S33(D5) | −206.423 | −205.599 | −206.805 |
| S7-S33(D6) | −181.88 | −181.249 | −182.202 |

In the present example, the distance by which the lens L14 is moved differs from the distance by which the lens L15 is moved when the projection distance is changed, as indicated by comparison between the values in the field S5-S33 and the values in the field S7-S33. That is, when the projection distance is changed from the reference distance J1 to the long distance J3, a first distance by which the lens L15 is moved from the first reference position P1 in the second direction Z2 is longer than a second distance by which the lens L14 is moved from the second reference position P2 in the second direction Z2, as indicated by the lengths of the arrows H and I in FIG. 11. When the projection distance is changed from the reference distance J1 to the short distance J2, a third distance by which the lens L15 is moved from the first reference position P1 in the first direction Z1 is longer than a fourth distance by which the second lens is moved from the second reference position P2 in the first direction Z1.

According to the present example, even when the projection distance is set at the long distance J3, the resolution comparable to that achieved when the projection distance is the reference distance J1 can be achieved. Further, even when the projection distance is set at the short distance J2, the resolution comparable to that achieved when the projection distance is the reference distance J1 can be achieved.

### Example 6

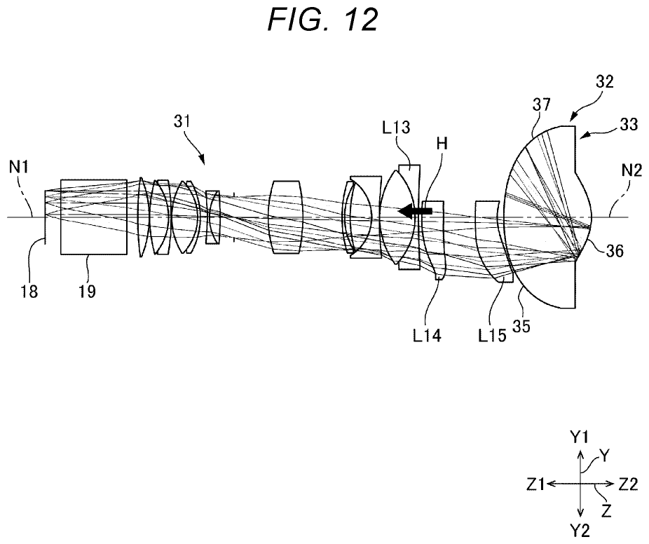

FIG. 12 describes Example 6. In the present example, when the projection distance is changed, only the lens L14 of the first optical system 31 is moved in the axis-Z direction. That is, when the projection distance is changed from the reference distance J1 to the long distance J3, the lens L14 is moved from the second reference position P2 in the first direction Z1, as indicated by the arrow H in FIG. 12. When the projection distance is changed from the reference distance J1 to the short distance J2, the lens L14 is moved from the second reference position P2 in the second direction Z2. The optical element 33 is fixed, and the optical element 33 is not moved when the projection distance is changed. The lenses L1 to L13 and the lens L15 of the first optical system 31 are fixed. The axial inter-surface distances at each of the projection distances of the projection system 3 are listed below.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −3.463575518 | −3.463575518 |
| S6(D2) | −14.54324832 | −14.22101085 | −14.63638938 |
| S8(D3) | −1.29871095 | −1.620948421 | −1.205569892 |
| S3-S33(D4) | −249.886 | −249.886 | −249.886 |
| S5-S33(D5) | −206.423 | −206.423 | −206.423 |
| S7-S33(D6) | −181.88 | −182.202 | −181.787 |

According to the present example, movement of one lens of the first optical system 31 in the axis-Z direction can change the projection distance. Since it is unnecessary to move the optical element 33, a decrease in precision of the positions of the first transmissive surface 35, the reflection surface 36, and the second transmissive surface 37 of the optical element 33 can be avoided when the projection distance is changed.

### Example 7

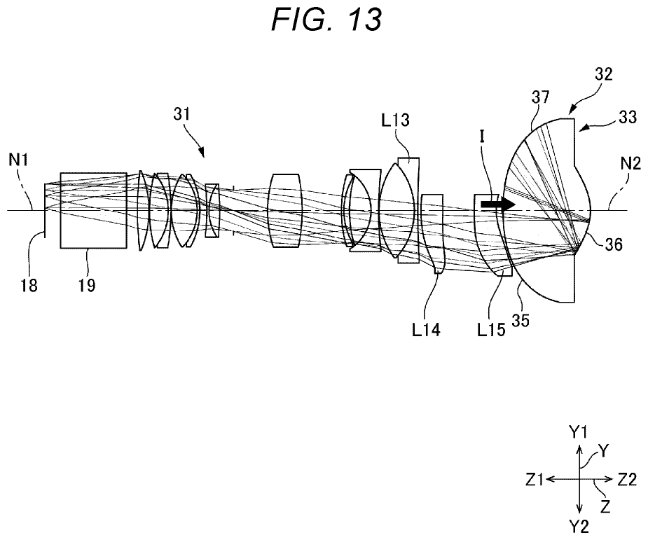

FIG. 13 describes Example 7. In the present example, when the projection distance is changed, the lens L15 of the first optical system 31 is moved in the axis-Z direction. That is, when the projection distance is changed from the reference distance J1 to the long distance J3, the lens L15 is moved from the first reference position P1 in the second direction Z2, as indicated by the arrow I in FIG. 13. When the projection distance is changed from the reference distance J1 to the short distance J2, the lens L15 is moved from the first reference position P1 in the first direction Z1. The optical element 33 is fixed and is not moved when the projection distance is changed. The lenses L1 to L14 of the first optical system 31 are fixed. The axial inter-surface distances at each of the projection distances of the projection system 3 are listed below.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −4.131132314 | −3.162086617 |
| S6(D2) | −14.54324832 | −13.87569152 | −14.84473722 |
| S8(D3) | −1.29871095 | −1.29871095 | −1.29871095 |
| S3-S33(D4) | −249.886 | −249.886 | −249.886 |
| S5-S33(D5) | −206.423 | −205.755 | −206.724 |
| S7-S33(D6) | −181.88 | −181.88 | −181.88 |

According to the present example, movement of one lens of the first optical system 31 in the axis-Z direction can change the projection distance. The present example readily allows suppression of occurrence of astigmatism when the projection distance is the long distance J3. Further, in the present example, since it is unnecessary to move the optical element 33, a decrease in precision of the positions of the first transmissive surface 35, the reflection surface 36, and the second transmissive surface 37 of the optical element 33 can be avoided when the projection distance is changed.

### Example 8

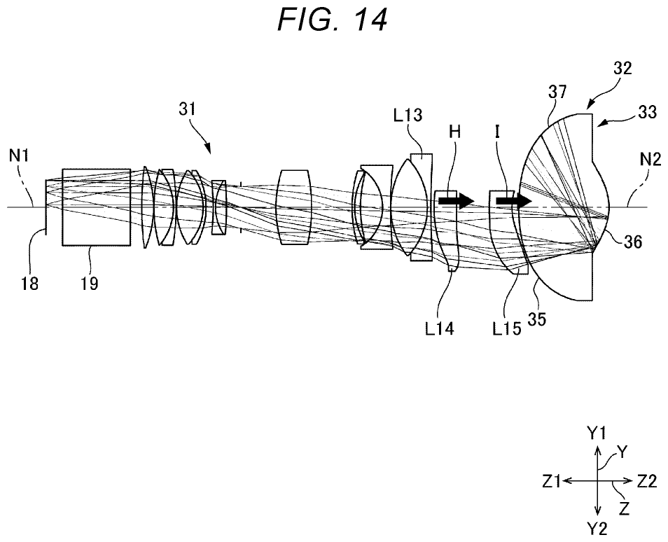

FIG. 14 describes Example 8. In the present example, when the projection distance is changed, the lenses L14 and L15 of the first optical system 31 are moved in the axis-Z direction. That is, when the projection distance is changed from the reference distance J1 to the long distance J3, the lens L14 is moved from the second reference position P2 in the second direction Z2, and the lens L15 is moved from the first reference position P1 in the second direction Z2, as indicated by the arrows H and I in FIG. 14. When the projection distance is changed from the reference distance J1 to the short distance J2, the lens L14 is moved from the second reference position P2 in the first direction Z1, and the lens L15 is moved from the first reference position P1 in the first direction Z1. The optical element 33 is fixed and is not moved when the projection distance is changed. The lenses L1 to L13 of the first optical system 31 are fixed. The axial inter-surface distances at each of the projection distances of the projection system 3 are listed below.

| | Reference | Short | Long |
|---|---|---|---|
| | distance J1 | distance J2 | distance J3 |
| S1 | 352.3808657 | 208.7089626 | 487.3816571 |
| S4(D1) | −3.463575518 | −4.268048587 | −3.141537125 |
| S6(D2) | −14.54324832 | −14.54324832 | −14.54324832 |
| S8(D3) | −1.29871095 | −0.494237881 | −1.620749344 |
| S3-S33(D4) | −249.886 | −249.886 | −249.886 |
| S5-S33(D5) | −206.423 | −205.618 | −206.745 |
| S7-S33(D6) | −181.88 | −181.075 | −182.202 |

In the present example, when the lenses L14 and L15 are moved, the axial inter-surface distance D2 between the lens L14 and the lens L15 is not changed, as indicated by the values in the field S6. That is, in the present example, the lenses L14 and L15 are moved by the same distance in the same direction when the projection distance is changed.

In the present example, occurrence of astigmatism can be suppressed irrespective of the projection distance. Further, according to the present example, the lenses L14 and L15 of the first optical system 31 can be moved integrally with each other. Therefore, even when the two lenses L14 and L15 are moved, the projection distance can be changed by providing the barrel or the frame with one movement mechanism that supports the lenses L14 and L15 in such a way that the lenses L14 and L15 are movable in the axis-Z direction. Further, in the present example, since it is unnecessary to move the optical element 33, a decrease in precision of the positions of the first transmissive surface 35, the reflection surface 36, and the second transmissive surface 37 of the optical element 33 can be avoided when the projection distance is changed.

### Example 9

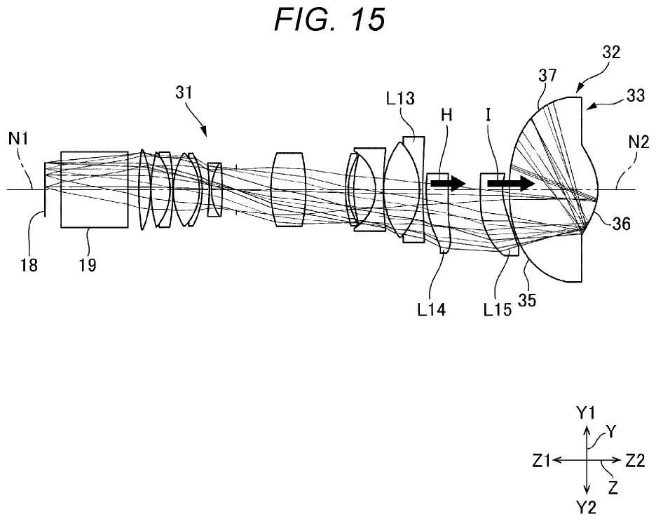

FIG. 15 describes Example 9. In the present example, when the projection distance is changed, the lenses L14 and L15 of the first optical system 31 are moved in the axis-Z direction. That is, when the projection distance is changed from the reference distance J1 to the long distance J3, the lens L14 is moved from the second reference position P2 in the second direction Z2, as indicated by the arrow H in FIG. 15, and the lens L15 is moved from the first reference position P1 in the second direction Z2, as indicated by the arrow I in FIG. 15. When the projection distance is changed from the reference distance J1 to the short distance J2, the lens L14 is moved from the second reference position P2 in the first direction Z1, and the lens L15 is moved from the first reference position P1 in the first direction Z1. The optical element 33 is fixed and is not moved when the projection distance is changed. The lenses L1 to L13 of the first optical system 31 are fixed. The axial inter-surface distances at each of the projection distances of the projection system 3 are listed below.

| | Reference | Short | Long distance |
|---|---|---|---|
| | distance J1 | distance J2 | J3 |
| S1 | 352.3808657 | 208.7089626 | 487.3816571 |
| S4(D1) | −3.463575518 | −4.246279979 | −3.138985654 |
| S6(D2) | −14.54324832 | −14.34201858 | −14.61566059 |
| S8(D3) | −1.29871095 | −0.717236231 | −1.550888548 |
| S3-S33(D4) | −249.886 | −249.886 | −249.886 |
| S5-S33(D5) | −206.423 | −205.64 | −206.748 |
| S7-S33(D6) | −181.88 | −181.298 | −182.132 |

In the present example, the distance by which the lens L14 is moved differs from the distance by which the lens L15 is moved when the projection distance is changed, as indicated by comparison between the values in the field S5-S33 and the values in the field S7-S33. That is, when the projection distance is changed from the reference distance J1 to the long distance J3, the first distance by which the lens L15 is moved from the first reference position P1 in the second direction Z2 is longer than the second distance by which the lens L14 is moved from the second reference position P2 in the second direction Z2, as indicated by the lengths of the arrows H and I in FIG. 15. When the projection distance is changed from the reference distance J1 to the short distance J2, the third distance by which the lens L15 is moved from the first reference position P1 in the first direction Z1 is longer than the fourth distance by which the second lens is moved from the second reference position P2 in the first direction Z1.

According to the present example, even when the projection distance is set at the long distance J3, the resolution comparable to that achieved when the projection distance is the reference distance J1 can be achieved. Further, even when the projection distance is set at the short distance J2, the resolution comparable to that achieved when the projection distance is the reference distance J1 can be achieved. Further, in the present example, since it is unnecessary to move the optical element 33, a decrease in precision of the positions of the first transmissive surface 35, the reflection surface 36, and the second transmissive surface 37 of the optical element 33 can be avoided when the projection distance is changed.

### Effects and Advantages

The projection system 3 according to the examples of the present disclosure includes the first optical system 31 and the second optical system 32 sequentially arranged from the reduction side toward the enlargement side. The second optical system 32 includes the optical element 33, which has the first transmissive surface 35, the reflection surface 36, and the second transmissive surface 37 sequentially arranged from the reduction side toward the enlargement side. The first and second lenses each have aspheric surfaces at opposite sides.

Therefore, in the projection system 3 according to the examples of the present disclosure, the second transmissive surface 37 can refract the light flux reflected off the reflection surface 36 in the second optical system 32. The projection distance of the projection system 3 can therefore be readily shortened as compared with a case where the second optical system 32 has only the reflection surface 36. In other words, the projection system 3 according to the examples of the present disclosure can be a short-focal-length projection system as compared with the case where the second optical system 32 has only the reflection surface 36.

Further, in the projection system 3 according to the examples of the present disclosure, at least one of the lens L15, which is located in a position closest to the enlargement side in the first optical system 31, and the lens L14, which is the second lens next to the lens closest to the enlargement side, in the first optical system 31 can be movable in the axis-Z direction along the first optical axis N1 of the first optical system 31. Focusing can therefore be performed, for example, when the projection distance of the projection system 3 is changed.

The second transmissive surface 37 of the optical element 33 has a convex shape protruding toward the enlargement side. The second transmissive surface 37 can therefore refract the light flux. The thus functioning second transmissive surface 37 can suppress inclination of the intermediate image 40, which is conjugate with the screen S, which is the enlargement-side image formation plane, with respect to the second optical axis N2 and the resultant increase in the intermediate image 40. An increase in the size of the reflection surface 36, which is located at the enlargement side of the intermediate image 40, can therefore be suppressed.

In the examples of the present disclosure, the intermediate image 40 is located between the first transmissive surface 35 and the reflection surface 36 of the optical element 33. The first optical system 31 and the optical element 33 are therefore allowed to approach each other as compared with a case where the intermediate image 40 is formed between the first optical system 31 and the optical element 33. The projection system 3 can thus be compact in the axis-Z direction.

Further, in the optical element 33, the first transmissive surface 35, the reflection surface 36, and the second transmissive surface 37 each have a rotationally symmetric shape around the second optical axis N2. The optical element 33 is therefore readily manufactured as compared with a case where the surfaces are not rotationally symmetric.

The pupil 41 of the second optical system 32 inclines with respect to the imaginary vertical line V perpendicular to the second optical axis N2. Therefore, in the projection system 3, a decrease in the amount of light at a periphery of the screen S that is the periphery at the upper side Y1 can therefore be suppressed as compared with a case where the pupil 41 is parallel to the imaginary vertical line V. That is, in the configuration in which the pupil 41 inclines with respect to the imaginary vertical line V perpendicular to the second optical axis N2, the amount of light flux F1, which reaches the upper portion of the screen S, increases as compared with the case where the pupil 41 is parallel to the imaginary vertical line V. Further, when the amount of light flux F1, which reaches the upper portion of the screen S, increases, the difference in the amount of light between the light flux F1 and the light flux F3, which reaches the lower portion of the screen S decreases. A decrease in the amount of light at the upper periphery of the screen S as compared with that at the lower periphery of the screen S can therefore be suppressed.

Further, in the optical element 33 in the examples of the present disclosure, the first transmissive surface 35, which is located at the reduction side of the intermediate image 40, is an aspheric surface, whereby occurrence of aberrations at the intermediate image 40 can be suppressed. Moreover, the reflection surface 36 and the second transmissive surface 37 of the optical element 33 are also each an aspheric surface. Occurrence of aberrations can therefore be suppressed in the enlargement-side image formation plane.

In the examples of the present disclosure, between the first optical system 31 and the second optical system 32, the gap between the chief rays therein decreases with distance to the second optical system 32. Therefore, the intermediate image 40 can be readily formed, and the size of the intermediate image 40 can be reduced. The size of the reflection surface 36, which is located at the enlargement side of the intermediate image 40, is readily reduced.

The projection system 3 can include a third optical system including an optical member, such as a lens and a mirror, at the enlargement side of the second optical system 32.

What is claimed is:

1. A projection system comprising:
a first optical system; and
a second optical system including an optical element and disposed at an enlargement side of the first optical system,
wherein the first optical system includes a first lens and a second lens disposed at a reduction side of the first lens,
the optical element has a first transmissive surface, a reflection surface disposed at the enlargement side of the first transmissive surface, and a second transmissive surface disposed at the enlargement side of the reflection surface,
the first lens has aspheric surfaces at opposite sides,
the second lens has aspheric surfaces at opposite sides, and
at least one of the first and second lenses is configured to move in an optical axis direction along a first optical axis of the first optical system.

2. The projection system according to claim 1,
wherein the optical element is fixed.

3. The projection system according to claim 1,
wherein the first and second lenses are both configured to move in the same direction along the optical axis direction.

4. The projection system according to claim 3,
wherein a first movement distance over which the first lens is moved is equal to a second movement distance over which the second lens is moved.

5. The projection system according to claim 3,
wherein a first movement distance over which the first lens is moved is longer than a second movement distance over which the second lens is moved.

6. The projection system according to claim 1,
wherein the first lens is disposed in a position closest to the enlargement side in the first optical system, and
the second lens is disposed in a position adjacent to the first lens.

7. A projection system comprising:
a first optical system; and
a second optical system including an optical element and disposed at an enlargement side of the first optical system,
wherein the first optical system includes a first lens and a second lens disposed at a reduction side of the first lens,
the optical element has a first transmissive surface, a reflection surface disposed at the enlargement side of the first transmissive surface, and a second transmissive surface disposed at the enlargement side of the reflection surface, and
the optical element is configured to move in an optical axis direction along a first optical axis of the first optical system.

8. The projection system according to claim 7,
wherein the first and second lenses are fixed.

9. The projection system according to claim 7,
wherein the second lens is configured to move in the optical axis direction, and
the optical element and the second lens are configured to move in the same direction along the optical axis direction.

10. The projection system according to claim 7,
wherein the first lens is configured to move in the optical axis direction,
the optical element is configured to move in a first direction along the optical axis direction, and
the first lens is configured to move in a second direction along the optical axis direction, the second direction being opposite to the first direction.

11. The projection system according to claim 7,
wherein the first and second lenses are configured to move in the optical axis direction, and
the optical element and the first and second lenses are configured to move in the same direction along the optical axis direction.

12. The projection system according to claim 11,
wherein a first movement distance over which the first lens is moved is equal to a second movement distance over which the second lens is moved.

13. The projection system according to claim 11,
wherein a first movement distance over which the first lens is moved is longer than a second movement distance over which the second lens is moved.

14. The projection system according to claim 7,
wherein the first lens is disposed in a position closest to the enlargement side in the first optical system, and
the second lens is disposed in a position adjacent to the first lens.

15. The projection system according to claim 1,
wherein a second optical axis of the reflection surface coincides with the first optical axis.

16. The projection system according to claim 15,
wherein the first transmissive surface, the reflection surface, and the second transmissive surface each have a rotationally symmetric shape around the second optical axis.

17. The projection system according to claim 15,
wherein the first transmissive surface and the reflection surface are disposed at one side of the second optical axis, and
the second transmissive surface is disposed at other side of the second optical axis.

18. The projection system according to claim 15,
wherein axes X, Y, and Z are three axes perpendicular to one another, an axis-X direction being a width direction of an enlargement-side image formation plane, an axis-Y direction being an upward/downward direction of the enlargement-side image formation plane, and an axis-Z direction being a direction perpendicular to the enlargement-side image formation plane,
a pupil that connects an upper intersection to a lower intersection inclines with respect to an imaginary vertical line that is perpendicular to the second optical axis in a plane YZ containing the first and second optical axes and extending in the axis-Y direction,
the upper intersection is an intersection where an upper peripheral light ray of an upper end light flux passing through an upper end of an effective light ray range of the second transmissive surface that is an upper end in the axis-Y direction and an upper peripheral light ray of a lower end light flux passing through a lower end of the effective light ray range that is a lower end in the axis-Y direction intersect each other in the plane YZ, and
the lower intersection is an intersection where a lower peripheral light ray of the upper end light flux and a lower peripheral light ray of the lower end light flux intersect each other in the plane YZ.

19. The projection system according to claim 1,
wherein the reflection surface has a concave shape,
the first transmissive surface has a convex shape protruding toward the reduction side, and
the second transmissive surface has a convex shape protruding toward the enlargement side.

20. The projection system according to claim 1,
wherein at least one of the reflection surface, the first transmissive surface, and the second transmissive surface is an aspheric surface.

21. The projection system according to claim 1,
wherein an intermediate image is formed at the reduction side of the reflection surface.

22. A projector comprising:
the projection system according to claim 1; and
an image formation section that forms a projection image in a reduction-side image formation plane of the projection system.

23. A projector comprising:
the projection system according to claim 7; and
an image formation section that forms a projection image in a reduction-side image formation plane of the projection system.
